(19) United States
(12) Patent Application Publication
(10) Pub. No.: US 2025/0148217 A1
(43) Pub. Date: May 8, 2025

(54) HYBRID INFERENCE FOR AN EFFICIENT, LOW LATENCY LLM-BASED ASSISTANT

(71) Applicant: GOOGLE LLC, Mountain View, CA (US)

(72) Inventors: Matthew Sharifi, Kilchberg (CH); Victor Carbune, Zurich (CH)

(21) Appl. No.: 18/387,768

(22) Filed: Nov. 7, 2023

(51) Int. Cl. G06F 40/40; G06F 40/166

(52) U.S. Cl. CPC G06F 40/40; G06F 40/166

(57) ABSTRACT

Implementations utilize a hybrid use of a smaller LLM and a larger LLM to generate and refine content responsive to a user query/request for content generation. In various implementations, the smaller LLM is utilized to process the user query for content generation, to generate initial content responsive to the user query for content generation. The user query for content generation and the initial content can be utilized to generate a text prompt, where the text prompt can be configured to further include a request for focused edit(s). Such a text prompt can be processed using the larger LLM, to generate focused edit(s) to the initial content that refine the initiated content, so that revised content (with improved accuracy) responsive to the user query for content generation is acquired.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilizations of generative models suffer from one or more drawbacks.

As one example, many generative models can be of a very large size, often including billions of parameters (e.g., over 100 billion parameters, over 250 billion parameters, or over 500 billion parameters). Due to the large size of such a generative model, significant memory, processor, power, and/or other computational resource(s) can be required to process an input, using the generative model, to generate a corresponding generative output. This resource utilization can be significant on a per input basis, and very significant when hundreds or thousands of inputs are being processed per minute, per second, or other interval. Also, due to the large size of such a generative model, there can be significant latency in generating a corresponding generative output and, as a result, in rendering corresponding generative content. Such latency can lead to prolonging of a user-to-computer interaction.

Smaller size counterparts to such generative models do exist, such as a separately trained counterpart with fewer parameters or a pruned and/or quantized counterpart generated from applying one or more pruning techniques and/or one or more quantization techniques to the larger counterpart. For example, a smaller counterpart to a larger model can include 25%, 33%, 50%, 66% or other percentage fewer parameters than the larger model. However, such smaller size counterparts can be less robust and/or less accurate than their larger size counterparts. Accordingly, while utilizing such a smaller size counterpart to process an input can be more computationally efficient and/or can be performed with less latency, there is a greater risk that corresponding generative output, generated by processing the input, can be inaccurate and/or under-specified.

### SUMMARY

Implementations disclosed herein are directed to utilizing a first generative model and a second generative model that have different computational efficiencies to respectively generate and refine content responsive to a user request. The first generative model can be more computationally efficient than is the second generative model, for instance, by having a smaller quantity of parameters. As a non-limiting example, the first generative model can be a smaller large language model (LLM) having less than 100 billion parameters, while the second generative model can be a larger LLM that includes over 200 billion parameters. In other examples, the first LLM can be a smaller LLM that includes twenty, thirty, forty, fifty, or other percent fewer parameters than the larger LLM.

By utilizing both the first generative model and the second generative model, implementations of this disclosure improve quality and/or accuracy of the content provided responsive to the user request while reducing latency in providing the content responsive to the user request. For example, various implementations utilize the more computationally efficient, first generative model in generating initial content responsive to the user request, so that a user can be presented with the initial content with reduced latency, thereby shortening an overall duration of a user/computer interaction. The various implementations also utilize the less computationally efficient, second generative model in refining the initial content, so that dynamic editing of the initial content can be presented/rendered to the user without the need for additional input(s) by the user, or with a reduced quantity of inputs of the user, to manually edit the initial content. This mitigates occurrences of the generated initial content being inaccurate and/or under-specified and, in turn, can mitigate occurrences of computational and/or network inefficiencies that result from further user edit(s) or the user issuing a follow-up (or new) request to cure the inaccuracies and/or under-specification of the generated initial content.

In these and other manners, implementations disclosed herein seek to reduce the overall duration of the user/computer interaction through utilization of the more computationally efficient first generative model. Further, those implementations also utilize the less computationally efficient second generative model to at least selectively refine initial content that is generated based on output generated using the first generative model, leveraging the more robust and/or more accurate second generative model to mitigate occurrences of inaccuracies and/or under-specification in the initial content. Yet further, those implementations seek to ensure that refinement(s), of the initial content, are made within the constraints of the initial content so that the efficiencies achieved through utilization of the more computationally efficient first generative model are not negated.

As a non-limiting working example, a user request to generate content (can also be referred to as “user request for content generation” or “user query for content generation”) that is a query of “write a 275-word email in a kind tone that talks about the need for innovation in a technology company” is received at a client device based on user interface input(s) from a user. In response to receiving the user request to generate content, the user request to generate content can be processed using the first generative model (e.g., the more computationally efficient/smaller LLM), to generate a first generative model output. Initial content responsive to the user request (to generate content) can be generated based on the first generative model output, and the initial content can be visually rendered via a user interface of the client device, for review by the user and/or to receive user edit(s) from the user. The initial content can include, for instance, text (e.g., message, email, report, post, etc.) that is responsive to the user request to generate content and can be decoded from the first generative model output.

In the above non-limiting working example, a text prompt can be generated based on the user request to generate content and the first generative model output, where the text prompt can further include a request for one or more focused edits. The request for one or more focused edits can be a request for generating a single focused edit (e.g., that edits a single text segment such as a sentence, a paragraph or other types of text segment) in each iteration out of one or more iterations. For instance, the request for one or more focused edits can include natural language text that requests the second generative model to perform one or more iterations of content refinement, where for each iteration of content refinement, a model output of the second generative model is used to provide/derive a single focused edit that edits a single text segment (e.g., sentence, paragraph, etc.). Alternatively, the request for one or more focused edits can be a request for generating the one or more focused edits all at once. Alternatively, the request for one or more focused edits can be a request for generating one or more focused edits per iteration of content refinement.

In some implementations, the text prompt can include the user request to generate content, the initial content output (as rendered via the user interface), and the request for one or more focused edits. The request for one or more focused edits (sometimes referred to as “request for focused edit(s)”, “request for focused edit”, etc.), for instance, can be a request to edit a single sentence (or paragraph, or a section, etc.) of the initial content that is visually rendered via the user interface and that is generated based on the first generative model output. In other words, the request for one or more focused edits is not intended to edit the entire initial content all at once, nor is it a request to generate entirely new content based on the user request to generate content. Rather, it is a request to edit only portion(s) (e.g., one or more text segments such as one or more sentences/paragraphs) of the initial content. In these and other manners, the text prompt is generated so that the robustness and/or accuracies of the less computationally efficient second generative model can be leveraged, while limiting the amount of processing that will be performed using the second generative model and/or ensuring that the efficiencies achieved through utilization of the more computationally efficient first generative model are not negated.

The generated text prompt can be provided to the second generative model (e.g., the less computationally efficient/larger LLM), which causes the generated text prompt to be processed using the second generative model, to generate a second generative model output. Based on the second generative model output, revised content can be generated (e.g., by decoding the second generative model output), where the revised content includes an LLM-based edit (sometimes referred to as “focused edit”) to the initial content. The LLM-based edit to the initial content, for instance, reflects an updated sentence that can be used to replace a sentence in the initial content. The LLM-based edit to the initial content (e.g., replacement of the sentence) can be automatically rendered at the aforementioned user interface, or the sentence can be highlighted or labeled with a graphical element indicating existence of a change, where the graphical element can be selectable (e.g., via a single tap, a single click, or other single user interface input) and when selected, causes the LLM-based edit to the initial content to be visually rendered/performed.

In some implementations, the smaller LLM can be a distilled, quantized and/or pruned version of the larger LLM. In some other implementations, the smaller LLM is not a quantized and/or pruned version of the larger LLM but, instead, is wholly independent of the larger LLM. For example, the smaller LLM can have a different architecture relative to the larger LLM and/or can be trained on a unique set of training data relative to the larger LLM. For instance, the input dimensions of the smaller LLM can be smaller than those of the larger LLM, the output dimensions of the smaller LLM can be smaller than those of the larger LLM, and/or the smaller LLM can include various intermediate layers that vary in size and/or type relative to those of the larger LLM.

The smaller LLM can be more computationally efficient than the larger LLM. For example, processing a request utilizing the smaller LLM can occur with less latency than processing the request utilizing the larger LLM. As another example, processing the request utilizing the smaller LLM can utilize less memory, processor, and/or power resource(s) than processing the request utilizing the larger LLM. In some implementations, the smaller LLM can be on-device at the client device, and the larger LLM can be remote to the client device. For instance, the larger LLM can be at a server device that is in communication with the client device.

Utilizing the smaller LLM (instead of the larger LLM) to generate the initial content and causing the generated initial content to be visually rendered responsive to the user request can more quickly satisfy informational needs of a user that provides the user request. Utilizing the larger LLM to perform one or more focused edits to the initial content can result in refined/revised content with improved accuracy and satisfactory quality when compared to the initial content. The one or more focused edits can be visually rendered for a user to review the revision of the initial content, for instance, in an automatic and sentence-by-sentence manner.

In some implementations, a user is allowed to edit the initial content and/or the refined/revised content with one or more user edits. For example, the user can be allowed to edit the refined content once no focused edit (i.e., generated based on second generative model output) is received. In other examples, the user can be allowed to edit the initial content via the user interface as soon as the initial content is rendered at the user interface, and/or can continue to edit the initial content while the one or more focused edits are applied to the initial content.

As a specific example, a first focused edit (of the one or more focused edits) that replaces or modifies a text segment (e.g., a single sentence, a single paragraph or other types of text segment) in the initial content can be visually and dynamically rendered via a display screen, followed by a second focused edit (of the one or more focused edits) that replaces or modifies an additional text segment in the initial content. In this specific example, if the user wants to provide user edit(s) while the second focused edit is being rendered via the display screen, the user can be allowed to edit multiple portions of the initial content (which may exclude a particular portion of the initial content that is currently shown as being modified/replaced by the second focused edit, as such particular portion is locked and thus not editable). In this specific example, the user may also be allowed to edit the text segment that has been replaced or modified by the first focused edit. In other words, when a focused edit is being applied to content (which can be the initial content, or intermediate content showing sentence(s) or other text segments modified or replaced based on focused edit(s)) shown via a display screen, a portion of the content being modified by the focused edit can be locked and not allowed for user edit(s) while the rest portion of the content can be unlocked and can be allowed for user edit(s). The intermediate content can refer to any content that is rendered visually (via the display screen) subsequent to the initial content but prior to final content (which incorporates all focused edit(s) determined using the second generative model, e.g., the larger LLM).

In some implementations, the user request to generate content can be processed to determine one or more query features, contextual feature(s), and/or attribute feature(s) associated with a client device and/or the user that provides the request. For example, when the request includes a natural language query (e.g., automatically generated or generated based on user interface input), the one or more query features can include: term(s) of the query; an embedding of the term(s) of the query (e.g., generated using a separate encoder); topic(s) or domain(s) reflected by the query; and/or other feature(s) derivable from the query. As another example, when the request includes a query with an image, the query feature(s) can include: an automatically generated caption of the image; descriptor(s) of object(s) automatically detected in the image; and/or other feature(s) derivable from the image. The contextual feature(s) can be or can include, for instance, a first feature relating to a tone of the user request (if the user request is an audible request) determined based on audio data capturing the user request. The attribute feature(s) can be determined, for instance, based on a user profile of the user.

In some implementations, the smaller or larger LLM is a sequence-to-sequence model, is transformer-based, and/or can include an encoder and/or a decoder. One non-limiting example of an LLM is Google's Pathways Language Model (PaLM). Another non-limiting example of an LLM is Google's Language Model for Dialogue Applications (LaMDA).

The preceding is presented as an overview of only some implementations disclosed herein. These and other implementations are disclosed in additional detail herein. For example, additional and/or alternative implementations are disclosed herein such as those directed to generating the one or more focused edits using the second generative model. In some implementations, to generate the one or more focused edits, the aforementioned text prompt (which includes the initial content, the user request to generate content, and the request for one or more focused edits) can be processed using the second generative model for a first iteration of content refinement, to generate a 1st second generative model output from which a first focused edit is determined. The first focused edit can be rendered at the user interface immediately following the determination of the first focused edit. The first focused edit can be applied to the text prompt automatically to update the text prompt, and the updated text prompt can be processed using the second generative model for a second iteration of content refinement, to generate a 2nd second generative model output from which a second focused edit is determined. The second focused edit can be rendered at the user interface immediately following the determination of the second focused edit. The second focused edit can be applied to the updated text prompt automatically to further update the updated text prompt, and the further updated text prompt can be processed using the second generative model for a third iteration of content refinement, to generate a 3rd second generative model output from which a third focused edit is determined. This focused edit determination process can be repeated until a Nth second generative model output of the second generative model indicates no focused edit is needed, where N is the total number of focused edits (i.e., N is a positive integer greater than zero).

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example of content generation and revision that demonstrates various aspects of the present disclosure, and in which some implementations disclosed herein can be implemented.

FIG. 2A illustrates an example of a user interface showing receipt of a user request to generate content, in accordance with various aspects of the present disclosure.

FIG. 2B illustrates an example of a user interface showing initial content generated in response to receiving a user request in FIG. 2A, in accordance with various aspects of the present disclosure.

FIG. 2C illustrates an example of a user interface showing a justification for a first focused edit to the initial content in FIG. 2B, in accordance with various aspects of the present disclosure.

FIG. 2D illustrates an example of a user interface showing a first focused edit to the initial content in FIG. 2B, in accordance with various aspects of the present disclosure.

FIG. 2E illustrates an example of a user interface showing a justification for a second focused edit, in accordance with various aspects of the present disclosure.

FIG. 2F illustrates an example of a user interface showing the second focused edit, in accordance with various aspects of the present disclosure.

FIG. 2G illustrates an example of a user interface showing a justification for a third focused edit, in accordance with various aspects of the present disclosure.

FIG. 2H illustrates an example of a user interface showing the third focused edit, in accordance with various aspects of the present disclosure.

FIG. 3 depicts a flowchart illustrating an example method of generating content responsive to a user request to generate content, in accordance with various aspects of the present disclosure.

FIG. 4 depicts a flowchart illustrating another example method of generating content responsive to a user request to generate content, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It is appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

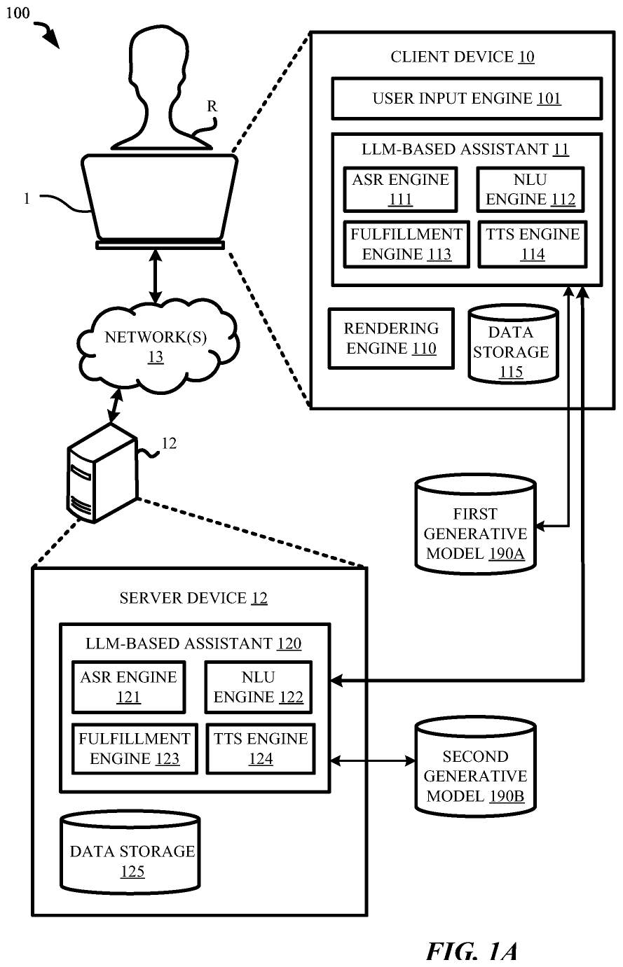

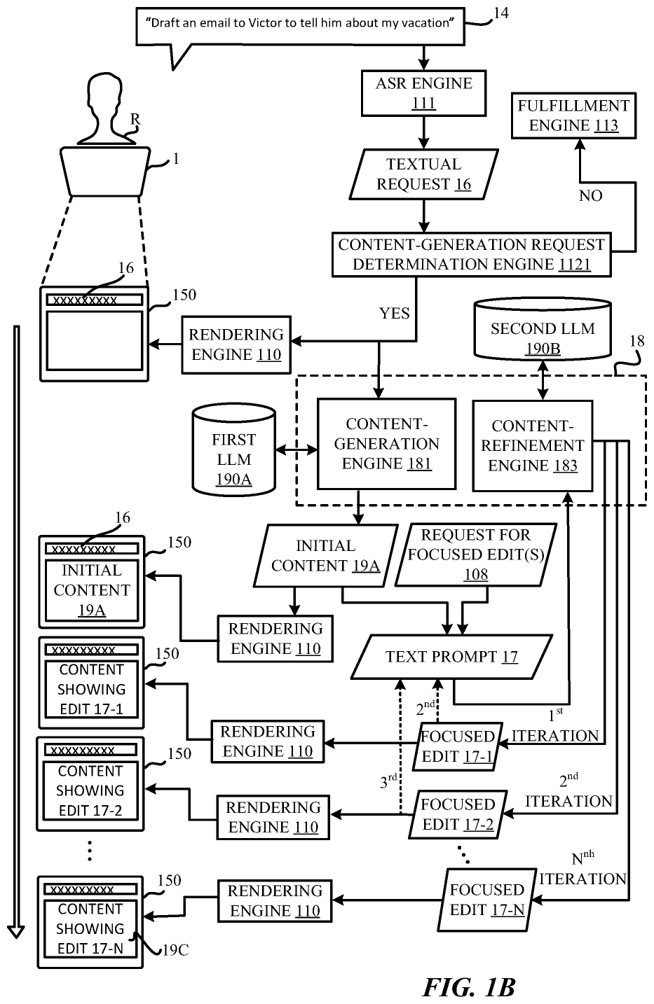

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) in communication with the client computing device 10 via one or more networks 13. The one or more networks 15 can include, for example, a local area network (LAN), a wide area network (WAN) such as the Internet, and/or any other appropriate network.

The client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a virtual or augmented reality computing device), and the present disclosure is not limited thereto.

In various implementations, the client computing device 10 can include a user input engine 101 that is configured to detect user input provided by a user of the client computing device 10 using one or more user interface input devices. For example, the client computing device 10 can be equipped with one or more microphones that capture audio data, such as audio data corresponding to spoken utterances of the user or other sounds in an environment of the client computing device 10. Additionally, or alternatively, the client computing device 10 can be equipped with one or more vision components that are configured to capture vision data corresponding to images and/or movements (e.g., gestures) detected in a field of view of one or more of the vision components.

Additionally, or alternatively, the client computing device 10 can be equipped with one or more touch sensitive components (e.g., a keyboard and mouse, a stylus, a touch screen, a touch panel, one or more hardware buttons, etc.) that are configured to capture signal(s) corresponding to touch input directed to the client computing device 10. Some instances of a query described herein, that can be included in a request, can be a query that is formulated based on user input provided by a user of the client computing device 10 and detected via user input engine 101. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client computing device 10 can include a local LLM-based assistant 11, a rendering engine 110, and/or a storage 115. In various implementations, the rendering engine 110 can be configured to provide content (e.g., a natural language-based response generated by an LLM) for audible and/or visual presentation to a user of the client computing device 10 using one or more user interface output devices. For example, the client computing device 10 can be equipped with one or more speakers that enable content to be provided for audible presentation to the user via the client computing device 10. Additionally, or alternatively, the client computing device 10 can be equipped with a display or projector that enables content to be provided for visual presentation to the user via the client computing device 10.

In various implementations, the local LLM-based assistant 11 can include a plurality of components including an automatic speech recognition (ASR) engine 111, a natural language understanding (NLU) engine 112, a fulfillment engine 112, and/or a text-to-speech (TTS) engine 114. The local LLM-based assistant 11 can optionally include a content-generation system (e.g., 18 in FIG. 1B) or a portion thereof (e.g., a content-generation engine of the content-generation system). In some implementations, a user R of the client computing device 10 may have a registered account associated with the local LLM-based assistant 11 and/or other third-party application(s). The third-party application(s) can include, for example, a note-taking application, a shopping application, a messaging application, and/or any other appropriate applications (or services), installed at (or accessible via) the client computing device 10.

The server computing device 12 can be, for example, a web server, a proxy server, a VPN server, or any other type of server as needed. The server computing device 12 can include a cloud-based LLM-based assistant 120. In various implementations, the cloud-based LLM-based assistant 120 installed at the server computing device 12 can be in communication with the local LLM-based assistant 11 installed at the client computing device 10. The cloud-based LLM-based assistant 120 can include cloud-based components the same as or similar to the plurality of local components of the local LLM-based assistant 11 locally installed at the client computing device 1. For example, the cloud-based LLM-based assistant 131 can include a cloud-based ASR engine 121, a cloud-based NLU engine 122, a cloud-based fulfillment engine 123, and/or a cloud-based TTS engine 124.

Optionally, the cloud-based LLM-based assistant 120 can include the content-generation system (e.g., 18 in FIG. 1B) or a portion thereof (e.g., a content-refinement engine). The local LLM-based assistant 11 and the cloud-based LLM-based assistant 120 can be referred to as “LLM-based assistant”.

The ASR engine 111 (and/or the cloud-based ASR engine 121) can process, using one or more streaming ASR models (e.g., a recurrent neural network (RNN) model, a transformer model, and/or any other type of ML model capable of performing ASR), streams of audio data that capture spoken utterances and that are generated by microphone(s) of the client computing device 10 to generate corresponding streams of ASR output. Notably, the streaming ASR model can be utilized to generate the corresponding streams of ASR output as the streams of audio data are generated.

The NLU engine 112 and/or the cloud-based NLU engine 122 can process, using one or more NLU models (e.g., a long short-term memory (LSTM), gated recurrent unit (GRU), and/or any other type of RNN or other ML model capable of performing NLU) and/or grammar-based rule(s), the corresponding streams of ASR output to generate corresponding streams of NLU output. The fulfillment engine 113 and/or the cloud-based fulfillment engine 123 can cause the corresponding streams of NLU output to be processed to generate corresponding streams of fulfillment data. The corresponding streams of fulfillment data can correspond to, for example, corresponding given assistant outputs that are predicted to be responsive to spoken utterances captured in the corresponding streams of audio data processed by the ASR engine 111 (and/or the cloud-based ASR engine 121).

The TTS engine (e.g., 114 and/or 124) can process, using TTS model(s), corresponding streams of textual content (e.g., text formulated by the LLM-based assistant 11) to generate synthesized speech audio data that includes computer-generated synthesized speech. The corresponding streams of textual content can correspond to, for example, one or more given assistant outputs, one or more of modified given assistant outputs, and/or any other textual content described herein. The aforementioned ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). In additional or alternatively implementations, corresponding streams of synthesized speech audio data corresponding to the one or more given assistant outputs, the one or more of modified given assistant outputs, and/or any other textual content described herein can be pre-cached in memory or one or more databases accessible by the client computing device 10, such that the LLM-based assistant need not use the TTS engine 114 (or 124) to generate the corresponding synthesized speech audio data.

In various implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 111 and/or 121 can select one or more of the ASR hypotheses as corresponding recognized text that corresponds to the spoken utterance(s) (e.g., selected based on the corresponding predicted measures).

In various implementations, the corresponding streams of NLU output can include, for example, streams of annotated recognized text that includes one or more annotations of the recognized text for one or more (e.g., all) of the terms of the recognized text, one or more corresponding predicted measures (e.g., probabilities, log likelihoods, and/or other values) for NLU output included in the streams of NLU output, and/or other NLU output. For example, the NLU engine 112 and/or 122 may include a part of speech tagger (not depicted) configured to annotate terms with their grammatical roles. Additionally, or alternatively, the NLU engine 112 and/or 122 may include an entity tagger (not depicted) configured to annotate entity references in one or more segments of the recognized text, such as references to people (including, for instance, literary characters, celebrities, public figures, etc.), organizations, locations (real and imaginary), and so forth. In some implementations, data about entities may be stored in one or more databases, such as in a knowledge graph (not depicted). In some implementations, the knowledge graph may include nodes that represent known entities (and in some cases, entity attributes), as well as edges that connect the nodes and represent relationships between the entities. The entity tagger may annotate references to an entity at a high level of granularity (e.g., to enable identification of all references to an entity class such as people) and/or a lower level of granularity (e.g., to enable identification of all references to a particular entity such as a particular person). The entity tagger may rely on content of the natural language input to resolve a particular entity and/or may optionally communicate with a knowledge graph or other entity database to resolve a particular entity.

Additionally, or alternatively, the NLU engine 112 and/or 122 may include a coreference resolver (not depicted) configured to group, or “cluster,” references to the same entity based on one or more contextual cues. For example, the coreference resolver may be utilized to resolve the term “them” to “buy theater tickets” in the natural language input “buy them”, based on “theater tickets” being mentioned in a client device notification rendered immediately prior to receiving input “buy them”. In some implementations, one or more components of the NLU engine 112 and/or 122 may rely on annotations from one or more other components of the NLU engine 112 and/or 122. For example, in some implementations the entity tagger may rely on annotations from the coreference resolver in annotating all mentions to a particular entity. Also, for example, in some implementations, the coreference resolver may rely on annotations from the entity tagger in clustering references to the same entity.

Additionally, or alternatively, the NLU engine 112 and/or 122 can include a content-generation request determination engine (e.g., 1121 in FIG. 1B) configured to determine, based on the corresponding streams of ASR and/or NLU output, whether the spoken request (or the textual request) is a request for content generation. It is noted that, in some implementations, the content-generation request determination engine may be separate from the NLU engine (i.e., not included in the NLU engine). In some implementations, in response to determining that the spoken request (or the textual request) is a request for content generation, the content-generation request determination engine can determine a type of the content (e.g., email, message, image, memo, summary, etc.).

In some implementations, the fulfillment engine 113 or 123 can include a content-generation engine (e.g., 181 in FIG. 1B) that processes the corresponding streams of NLU output, to determine initial content responsive to the spoken request (or the textual request). The determined content responsive to the spoken request (or the textual request) can be rendered at a user interface, for instance, by the rendering engine 110. The content-generation engine can, for instance, process the corresponding streams of NLU output as input using a first generative model (e.g., the aforementioned smaller LLM which is more computational efficient), to generate the first generative model output (may also be referred to as “smaller generative model output”) from which the initial content responsive to the spoken request (or the textual request) is determined.

Additionally, or alternatively, the fulfillment engine 113 or 123 can include a content-refinement engine (e.g., 183 in FIG. 1B) that processes the initial content, to determine refined/revised content responsive to the spoken request (or the textual request). The content-refinement engine can, for instance, iteratively process a text prompt including both the initial content and a request for focused edit(s) as input, using a second generative model (e.g., the aforementioned larger LLM which is less computationally efficient), to generate one or more second generative model outputs (may also be referred to as “one or more larger generative model output”) from which one or more focused edits are determined. It is noted that the text prompt processed as input using the second generative model can be different in different iterations of content refinement. For instance, the text prompt processed using the second generative model for the first iteration of content refinement (“1st iteration”) can include the initial content and the request for focused edit(s), while the text prompt processed using the second generative model for the second iteration of content refinement (“2nd iteration”) can include the initial content having a first sentence updated based on a first focused edit (generated based on model output of the second generative model for the 1st iteration) and include the request for focused edit(s).

In some implementations, the request for focused edit(s) can be, for instance, a textual request that requests edit (e.g., by the larger LLM) to one and only one sentence in the initial content during each iteration of content refinement. The request for focused edit(s) can alternatively be, for instance, a textual request that requests edit (e.g., by the larger LLM) to one and only one paragraph in the initial content during each iteration of content refinement. Descriptions of the request for focused edit(s) are, however, not limited thereto.

In various implementations, the rendering engine 110 can cause the initial content to be rendered visually via a user interface of the client computing device 10, where the initial content is rendered in response to the spoken request (for content generation). The rendering engine 110 can further cause the one or more focused edits to the initial content be rendered automatically via the user interface of the client computing device 10. In some implementations, the one or more focused edits can be rendered simultaneously at the user interface. For instance, the initial content can be edited automatically to reflect the one or more focused edits all at once, resulting in the replacement of the initial content with refined content that incorporates all the one or more focused edits into the initial content.

In some other implementations, the one or more focused edits can be rendered one-by-one at the user interface. For instance, the initial content can be edited automatically to render/reflect a first focused edit (from the one or more focused edits) at a first time, to render/reflect a second focused edit (from the one or more focused edits) at a second time subsequent to the first time, . . . , and to render/reflect a Nth focused edit (from the one or more edits) at a N^{th} time (assuming N is the total number of the one or more focused edits). Optionally, the time interval between different moments that two adjacent focused edits (e.g., the first and second focused edits) are rendered can be predetermined. For instance, the time interval between the first time and the second time can be pre-configured to be 1.0 second or any other appropriate length.

Optionally or alternatively, the initial content can be edited automatically to render/reflect a first focused edit in response to receiving the first focused edit (which is decoded from corresponding model output of the second generative model), and the second focused edit can be automatically rendered in response to receiving the second focused edit (which is decoded from corresponding model output of the second generative model). In other words, the first time (when the first focused edit is initiated or rendered) and the second time (when the second focused edit is initiated or rendered) can be based on the time the second generative model completes the first iteration of content refinement and the second iteration of content refinement, respectively, and be additionally based on factors such as network connections for the client computing device 10 to receive the first focused edit and the second focused edit from the second generative model (in case the second generative model is accessed or stored in the server computing device 12).

In some implementations, in response to a first larger generative model output being generated by the second generative model based on processing of a first text prompt (that includes both the initial content and the request for focused edit(s)) during a first iteration, a first focused edit to the initial content can be determined and be rendered by the rendering engine 110 at the user interface at which the initial content is displayed. In some implementations, the first focused edit can be accompanied by a justification for the first focused edit, and the justification for the first focused edit can be rendered by the rendering engine 110. The justification for the first focused edit can be rendered simultaneously with the first focused edit and stay being rendered while the first focused edit is displayed dynamically (e.g., showing the deleting of a first initial sentence and the adding of a first replacement (or revised) sentence). Details of the rendering will be provided elsewhere in this disclosure and are omitted herein for the sake of clarity. In some implementations, the justification for the first focused edit and the first focused edit can be both derived from output of the second generative model (that corresponds to the first text prompt which includes both the initial content and the request for focused edi(t)) generated during the first iteration of content refinement.

In response to a second larger generative model output being generated by the second generative model based on processing of a second text prompt (that includes the initial content refined to incorporate the first focused edit and the request for focused edit(s)) during a second iteration of content refinement, a second focused edit to the initial content can be determined and be rendered by the rendering engine 110 at the user interface. In some implementations, the second focused edit can be accompanied by a justification for the second focused edit, and the justification for the second focused edit can be rendered by the rendering engine 110. In some implementations, the justification for the second focused edit as well as the second focused edit can be determined from output of the second generative model (that corresponds to the second text prompt) generated during the second iteration of content refinement. In some implementations, the second text prompt can be generated automatically in response to determination of the first focused edit. In other words, responsive to the first focused edit being determined based on output (e.g., the second larger generative model output) of the second generative model generated during the second iteration of content refinement, the second text prompt can be generated to include the request for focused edit(s) and the initial content refined to incorporate the first focused edit.

This focused edit determination and rendering process can be repeated for N times, where N can be a predetermined positive integer or N is determined based on processing using the second generative model until, for instance, no focused edit is determined to exist by the second generative model.

In other words, in response to a N^{th} larger generative model output being generated by the second generative model based on processing of the text prompt (that includes both the initial content refined with the first focused edit ˜(N−1)^{th} focused edit, and/or the request for focused edit(s)) during a N^{th} iteration of content refinement, a N^{th} focused edit to the initial content can be determined and be rendered by the rendering engine 110 at the user interface. In some implementations, the N^{th} focused edit can be accompanied by a justification for the Nth focused edit, and the justification for the N^{th} focused edit can be rendered by the rendering engine 110 at the user interface. In some implementations, optionally, a prompt can be additionally rendered by the rendering engine 110 (but not necessarily required) to notify the user that content refinement to the initial content has been completed.

In some implementations, instead of rendering all the one or more focused edits, a subset of the one or more focused edits can be selectively rendered. For example, output of the second generative model from which a corresponding focused edit is determined/generated can include a confidence score for the corresponding focused edit, and when the confidence score for the corresponding focused edit does not satisfy a rendering recommendation threshold score (e.g., 0.7 out of 1.0), the rendering engine 110 can determine to not render the corresponding focused edit at the user interface, while causing all other focused edits having a confidence score satisfying the rendering recommendation threshold score to be rendered at the user interface.

In some implementations, optionally, output of the aforementioned first generative model from which the initial content is determined/generated can further include an inference indicating/identifying one or more particular sentences in the initial content to be refined. Such inference indicating the one or more particular sentences in the initial content to be refined can also be included in the text prompt that is transmitted to the second generative model, so that the second generative model can be utilized in providing one or more LLM-based edits that edit the one or more particular sentences, respectively.

In some implementations, instead of performing N^{th} iteration of content refinement, the second generative model can be configured to perform a single iteration of content refinement, where one or more model outputs can be generated by the second generative model (e.g., all at once) during the single iteration of content refinement. The one or more model outputs can each be decoded or derived to determine a corresponding focused edit. For instance, the aforementioned text prompt can be processed as input, using the second generative model, to generate a plurality of model outputs (e.g., a model output O1, a model output O2, and a model output O3) all at once, where a focused edit can be derived from the model output O1, an additional focused edit can be derived from the model output O2, and a further focused edit can be derived from the model output O3. The focused edit, the additional focused edit, and the further focused edit may be rendered visually to a user (e.g., simultaneously, or in an order of being decoded and received by a computing device that is to render focused edit(s) to the initial content). Optionally, only one or more model outputs of the plurality of model output having a confidence score that satisfies the aforementioned rendering recommendation threshold score are selectively rendered to the user. For instance, if only the model output O2 includes a confidence score (e.g., 0.8) that is higher than the rendering recommendation threshold score (e.g., 0.7), only the additional focused edit is transmitted from a server device that hosts the second generative model to the computing device that is to render the focused edit(s) and is rendered to the user via a display of the computing device, while the focused edit and the further focused edits are not transmitted and are not rendered to the user.

In some implementations, a training instance to train the first generative model can be generated based on the user request for content generation and based on the initial content incorporating the one or more focused edits (which are determined using the second generative model). For instance, the training instance can include the user request for content generation as training instance input, and include the initial content incorporating all of the one or more focused edits (which may be referred to as “final refined content”) as ground truth output. The training instance can be applied to train the first generative model by: processing the user request for content generation as input using the first generative model to generate a training model output, comparing the training model output with the ground truth output to determine a difference, and adjusting one or more parameters/weights of the first generative model based on the difference between the training model output with the ground truth output. It is noted that different user requests for content generation can be collected/stored, and correspondingly, different focused edits that correspond to the different user requests for content generation can be collected/stored. This way, different training instances can be generated as described above. These different training instances can be applied to train the first generative model, or to fine-tune the first generative model in a particular domain (e.g., in writing reports, or in writing summaries, etc.)

In some implementations, optionally, the text prompt to be provided/transmitted to the second generative model to initiate the iterative processes of focused edit generation can further include a word-limit (e.g., 200 words, 500 words, etc.), in addition to the user request for content generation and in addition to the initial content, so that the refined content can be relatively concise, or can satisfy the word-limit requirement.

In some implementations, the aforementioned user interface (e.g., 150 in FIG. 1B) at which the initial content or the refined content is visually rendered can include one or more user controls (e.g., selectable graphical elements that enable user interaction with the initial and/or refined content). The one or more user controls can enable the user to provide one or more user edits to the initial content and/or to the refined content (i.e., the initial content incorporating the one or more focused edits if the refined content is final refined content, or the initial content incorporating a portion of the one or more focused edits if the refined content is intermediate refined content). In these implementations, one or more training instances to train the first generative model can be generated to include, for instance, (1) the user request for content generation as training instance input and (2) the initial content that incorporates the one or more focused edits (determined using the second generative model) and that incorporates the one or more user edits, as ground truth output. Training of the first generative model using these one or more training instances can be similar to descriptions provided elsewhere of this disclosure, and repeated descriptions are omitted herein.

As a working example, referring to FIG. 1B, a user (e.g., user R) can provide a spoken request 14 (e.g., “draft an email to Victor to tell him about my vacation”, or “draft a document about the summit in Zurich and share it with Victor”, etc.) to the client computing device 1. The spoken request 14 can be processed by the ASR engine 111 (and/or 121), e.g., using the one or more streaming ASR models, to generate corresponding streams of ASR output based on which the spoken request (e.g., “draft an email to Victor to tell him about my vacation”) is converted into a textual request 16 (e.g., “draft an email to Victor to tell him about my vacation” in natural language). In some implementations, the textual request 16 (e.g., “draft an email to Victor to tell him about my vacation” in natural language) can be processed by the NLU engine 112 (and/or 122), e.g., using the one or more NLU models, to generate corresponding streams of NLU output.

In the above working example, a content-generation request determination engine 1121 can determine, based on the corresponding streams of ASR and/or NLU output, that the spoken request 14 (“draft an email to Victor to tell him about my vacation”) is a request for content generation. In response to determining that the spoken request 14 (“draft an email to Victor to tell him about my vacation”) is a request for content generation, the rendering engine 110 can cause a content-generation user interface (UI) 150 to be rendered at the client computing device 10. Optionally, in response to determining that the spoken request 14 (“draft an email to Victor to tell him about my vacation”) is a request for content generation, a type (e.g., email) of the content to be determined, and the rendering engine 110 can render the content-generation UI based on the determined type of the content to be generated. Put another way, different content-generation UI can be pre-configured and rendered for different types of the content to be generated.

As a non-limiting example, a first content-generation UI can be pre-configured and rendered when the content to be generated is determined to have a type of an email, and a second content-generation UI can be pre-configured and rendered when the content to be generated is determined to have a type of a report, where the first and second content-generation UIs can include different graphical elements. For instance, the first content-generation UI can include a first selectable graphical element which when selected, causes a list of email addresses to be rendered (e.g., as a drop-down menu) at the first content-generation UI, for selection or adding or deleting of a recipient by a user. The second content-generation UI can include a second selectable graphical element which when selected, causes a letterhead (or other aspects of a report) to be rendered at the second content-generation UI, for user selection and/or user edit.

If the content-generation request determination engine 1121 determines, based on the corresponding streams of ASR and/or NLU output, that the spoken request 14 is not a request for content generation, the textual request 16 may be routed to the NLU engine 112 (if the content-generation request determination engine 1121 is not included in the NLU engine 112) or can be routed to other components of the NLU engine 112 (if the content-generation request determination engine 1121 is included in the NLU engine 112), to determine an intent and/or association parameters, for an action (e.g., other than content generation, such as “turn off the light”) corresponding to the spoken request 14 to be determined and fulfilled using the fulfillment engine 113.

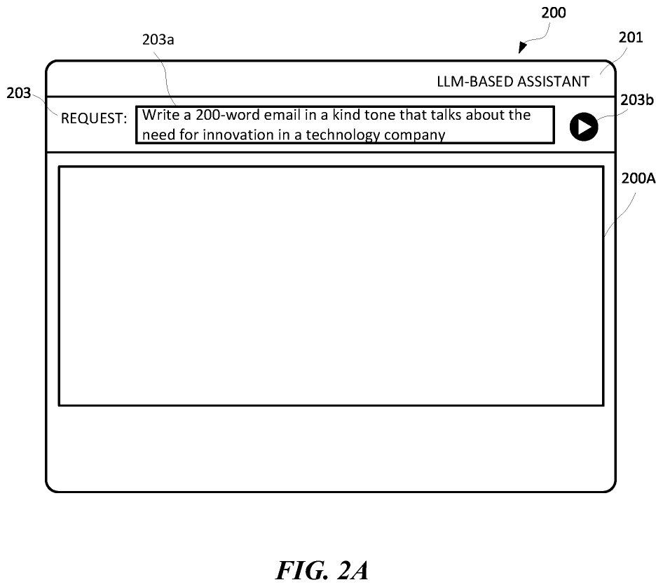

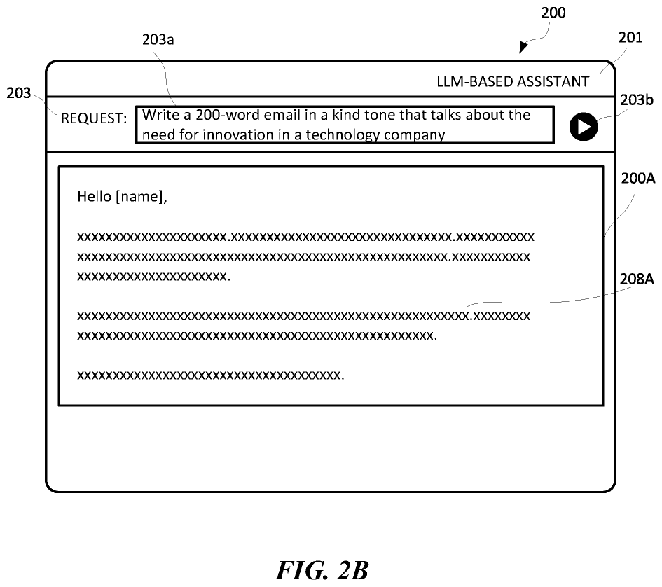

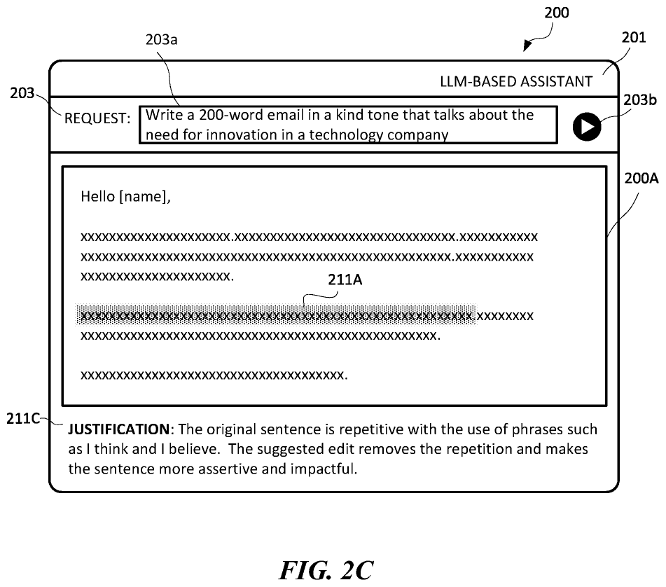

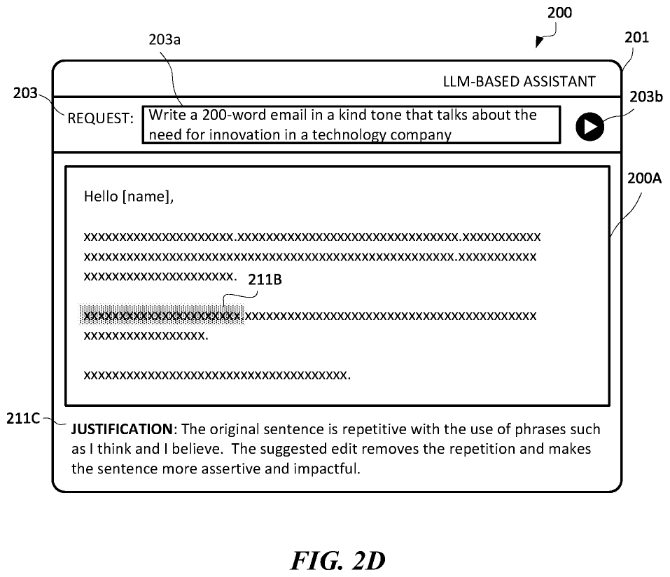

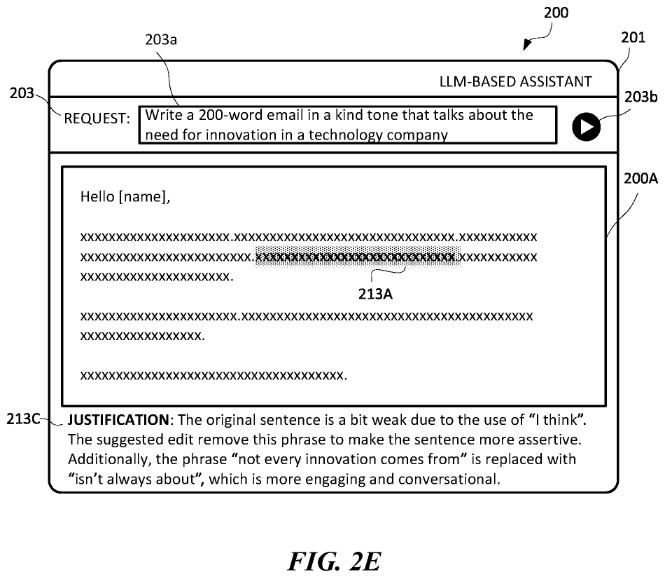

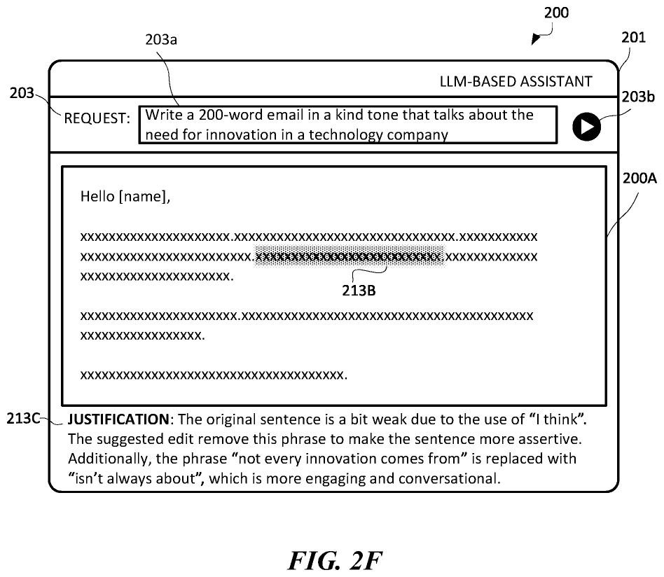

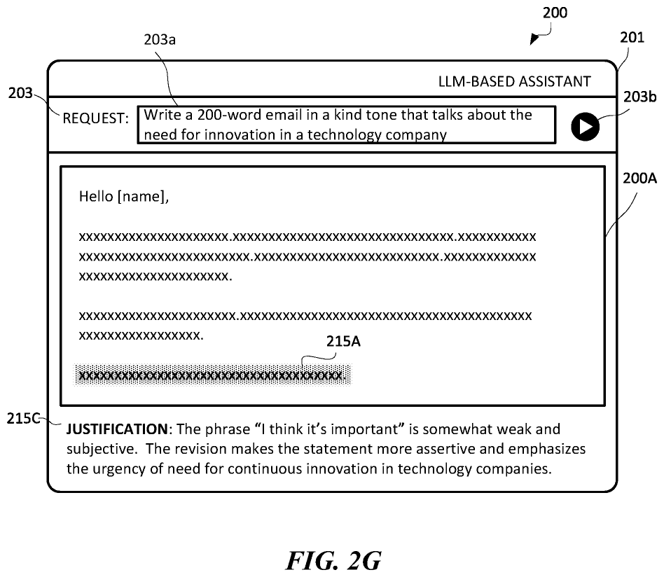

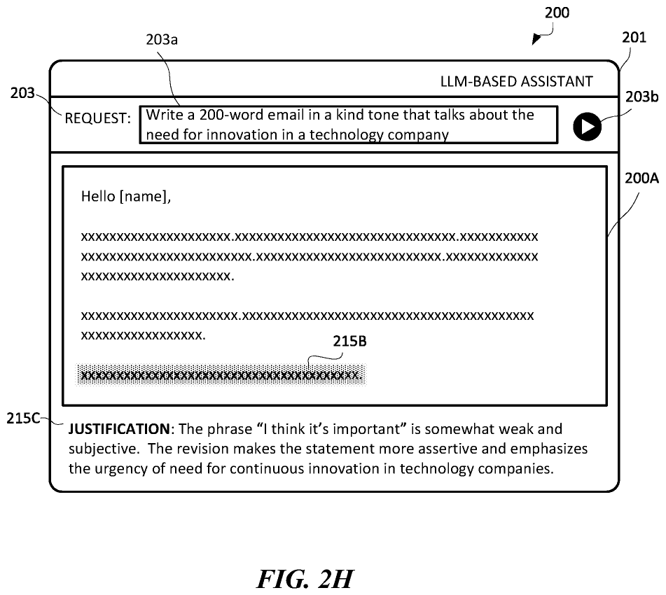

The content-generation UI 150 can be a pre-configured user interface of the LLM-based assistant, where the pre-configured user interface can include a request-displaying region (e.g., 203 in FIG. 2A) having a content request input field 161. The content request input field 161 can, for instance, list the textual request 16 (e.g., “draft an email to Victor to tell him about my vacation” in natural language) that is provided by a user at the content request input field 161 or that is converted from the spoken request 14 of “draft an email to Victor to tell him about my vacation”. In some implementations, the content request input field 161 can enable a user to edit the textual request before submitting the textual request 16 to a content-generation system 18 (which can include a content generation engine 181), for initial content 19A (e.g., an initial email to Victor describing vacation of a user that provides the spoken request) responsive to the spoken request to be generated. The content-generation system 18 can be included, for instance, in the LLM-based assistant 11.

In some implementations, the user needs not submit the textual request 16 to the content-generation system 18 for the initial content responsive to the spoken request to be generated. For instance, the user can provide the spoken utterance 14 of “draft an email to Victor to tell him about my vacation” (or provide the textual request 16 via a keyboard, mouse, touchpad, etc.) to the LLM-based assistant 11, and in response to determining that the spoken utterance 14 of “draft an email to Victor to tell him about my vacation” is a request for content generation (“content-generation request”) and that the spoken utterance 14 of “draft an email to Victor to tell him about my vacation” is a complete request (e.g., by determining that no additional user input is received in a predetermined subsequent period of time, e.g., 5 seconds following the spoken utterance 14), the textual request 16 converted from the spoken request 14 can be submitted to the content generation engine 181 automatically for the initial content (e.g., 19A) to be generated.

The initial content 19A responsive to the spoken request, e.g., an initial email to Victor describing vacation of a user that provides the spoken request, can be generated, for instance, based on processing of a speech recognition of the spoken utterance 14 (e.g., “draft an email to Victor to tell him about my vacation”) using the aforementioned first generative model (e.g., first/smaller LLM 190A). The initial content 19A can be rendered at the user interface 150 automatically in response to the initial content 19A being generated. It is noted that by utilizing the smaller LLM 190A (which is more computationally efficient) to derive the initial content 19A, the latency in rendering the initial content 19A can be reduced. For instance, the initial content 19A may be rendered shortly after the user interface 150 is rendered.

Continuing with the working example above, a text prompt 17 can be generated based on the initial content 19A responsive to the spoken request 14 and a request for focused edit(s) 108 to the initial content. For instance, the text prompt 17 can include the initial content 19A responsive to the spoken request 14 and the request for focused edit(s) 108 to the initial content, where the request for focused edit(s) 108 to the initial content can be a natural language request that requests edit of a single sentence (or other segment) in the initial content during a single iteration of content refinement using the second generative model. Alternatively or additionally, the text prompt 17 can include one or more additional requests, where the one or more additional requests can include a format request (e.g., font, font size, a particular sentence or session, etc.), a word-limit request, a writing style request (e.g., tone), etc.

The text prompt 17 can be provided to a content-refinement engine 183, where the providing causes the text prompt 17 to be processed as input, using the second generative model (e.g., the larger/second LLM 190B), for one or more iterations of content refinement. In some implementations, for each of the multiple iterations of content refinement (e.g., N iterations), the text prompt 17 can be varied, and the varied text prompt 17 can be processed as input using the second generative model to generate a corresponding model output from which a corresponding focused edit 17-n (that edits a single sentence in the initial content) is derived.

For instance, during a first iteration of the N iterations, the text prompt 17 including the initial content and the request for focused edits can be processed as input using the second generative model, to generate output from which the first focused edit 17-1 is generated. The first focused edit 17-1 can be rendered at the user interface 150, for instance, to replace a first sentence in the initial content 19A that is rendered at the user interface 150. The first focused edit 17-1 (generated during the 1st iteration) can also be applied to update the initial content 19A in the text prompt 17, so that a second text prompt can be generated to include the initial content 19A that incorporates the first focused edit 17-1 and/or the request for focused edits. The second text prompt can be processed using the second generative model during a 2nd iteration, to generate an output from which a second focused edit 17-2 is generated. The second focused edit 17-2 can be applied to the initial content 19A that incorporates the first focused edit 17-1 (if such edit is not reverted or rejected by the user) and can also be applied to update the second text prompt to initiate a third iteration of content refinement using the second generative model. This process can be repeated until a predefined iteration (e.g., the N^{th} iteration) is reached or until output of the second generative model indicates no focused edit is present or generated.

In some implementations, the corresponding focused edit 17-n (where n=1, 2, . . . . N) can be rendered instantly at the user interface once determined, which allows a user to view automatic rendering of a chain of one or more focused edits (also referred to as “LLM-based edits”) to the initial content.

Continuing with the working example above, in some implementations, after all of the focused edits (e.g., 17-1, 17-2, . . . , 17-N) are applied to the initial content 19A, refined/revised content 19C (may also referred to as “refined content”) may be presented to the user. In some implementations, user edit(s) (if any) to the refined content 19C can be received from the user, to generate final content. The content-generation UI 150, for instance, can include a particular selectable element (e.g., a button, not depicted) that when selected, causes the refined content 19C (if no further user edit) or the final content (if further user edits are received) to be transmitted to a third-party application (e.g., an email application).

In some implementations, optionally, the selection of the particular selectable element can further cause the third-party application to be launched in a particular state where a user interface of the third-party application 105 is rendered to display the transmitted revised content 19C (or the transmitted final content if user edit is received). In some implementations, alternatively, the selection of the particular selectable element can further causes the third-party application to automatically send the transmitted revised content 19B or the transmitted final content 19C to a recipient (e.g., “Victor” that is identified in the spoken request 14), without having the third-party application 105 to be launched in the particular state.

FIG. 2A illustrates an example of a user interface showing receipt of a user request to generate content, in accordance with various aspects of the present disclosure. FIG. 2B illustrates an example of a user interface showing initial content generated in response to receiving a user request in FIG. 2A, in accordance with various aspects of the present disclosure. FIG. 2C illustrates an example of a user interface showing a justification for a first focused edit to the initial content in FIG. 2B, in accordance with various aspects of the present disclosure. FIG. 2D illustrates an example of a user interface showing a first focused edit to the initial content in FIG. 2B, in accordance with various aspects of the present disclosure. FIG. 2E illustrates an example of a user interface showing a justification for a second focused edit, in accordance with various aspects of the present disclosure. FIG. 2F illustrates an example of a user interface showing the second focused edit, in accordance with various aspects of the present disclosure. FIG. 2G illustrates an example of a user interface showing a justification for a third focused edit, in accordance with various aspects of the present disclosure. FIG. 2H illustrates an example of a user interface showing the third focused edit, in accordance with various aspects of the present disclosure.

As shown in FIG. 2A, a content-generation user interface (UI) 200 is provided. The content-generation UI 200 can be (not does not necessarily need to be) of an LLM-based assistant 201. The content-generation UI 200 can include a user request section 203 that includes a content request input field 203a. The content request input field 203a can receive a textual input from a user, such as “Write a 275-word email in a kind tone that talks about the need for innovation in a technology company”. The content request input field 203a can alternatively display a textual request (e.g., “Write a 275-word email in a kind tone that talks about the need for innovation in a technology company” in natural language) that is converted from a spoken request (e.g., a user utterance of “Write a 275-word email in a kind tone that talks about the need for innovation in a technology company”) from the user. In various implementations, the content request input field 203a enables the user to edits the textual input from the user (or the textual request converted from the spoken request from the user) before transmitting the textual input (or the textual request converted from the spoken request) for processing using a first generative model (e.g., to generate initial content (e.g., 208A in FIG. 2B) that is responsive to the textual input (or the textual request converted from the spoken request)). The initial content 208A for instance, can be rendered visually within a preview section 200A of the content-generation UI 200, to be reviewed and/or edited by a user.

In some implementations, optionally, the textual input from the user (or the textual request converted from the spoken request from the user) can be transmitted to the first generative model automatically (i.e., without user input that triggers such transmission) in response to determining that the text input (or the textual request) is complete (e.g., by determining that no additional input is received within a predetermined period of time subsequent to receiving the text input or the textual request). In some implementations, optionally, the textual input from the user (or the textual request converted from the spoken request from the user) can be transmitted to the first generative model in response to a user selecting a user request submission element 203b which is selectable and when selected, causes a text (i.e., the textual input or the textual request converted from the spoken request) shown in the content request input field 203a to be transmitted to the first generative model, for processing using the first generative model.

The first generative model can be, for instance, a trained LLM that is of a relatively small size, such as a “smaller LLM” having a first quantity of parameters (e.g., in the order of millions or a billion, etc.) Due to the relatively small size of the first generative model (i.e., the trained LLM of the first quantity of parameters), memory, processor, power, and/or other computational resource(s) required to process the textual input (such as “Write a 275-word email in a kind tone that talks about the need for innovation in a technology company”) using the first generative model (in order to generate the initial content) can be relatively insignificant. Also, due to the relatively small size of the first generative model, a latency in generating the initial content and, as a result, in rendering the initial content, can be relatively insignificant. Such insignificant latency may allow the user to review and read the initial content instantly while the initial content is being transmitted and/or processed for refinements using a second generative model that is of a relatively large size, such as a “larger LLM” having a second quantity of parameters (e.g., in the order of billions, tens of billions, or a hundred of billions, etc.)

In various implementations, a text prompt can be generated to include the initial content 208A generated using the first generative model and to include a request for one or more focused edits. The request for one or more focused edits can be, for instance, “review the following initial content and suggest the most important edit by replacing a sentence in the initial content”, or “review the following draft text and suggest the most important edit in the form of ‘original sentence’-> ‘new sentence’. Provide a short justification for your edit, prefix it with ‘Justification’. Replace only one sentence.” It is noted that the request for one or more focused edits may or may not be rendered via the content-generation UI 200. It is further noted that the specific content of the request for one or more focused edits is, however, not limited herein, and can include any other appropriate content. The generated text prompt can be transmitted to the second generative model, where the transmission can cause multiple iterations of content refinement to be performed using the second generative model.

For example, referring to FIG. 1C and FIG. 1D, during a first iteration of content refinement, a first sentence 211A in the initial content can be edited by being replaced with an updated first sentence 211B, while all other sentences in the initial content remain unchanged. As a non-limiting example, the first sentence 211A can be—“I think this approach is important, and I believe it has the potential to revolutionize the way we do business.”, and the updated first sentence 211B can be—“This approach is not only important, but I believe it has the potential to revolutionize the way we do business”. The replacement of the first sentence 211A with the updated first sentence 211B can be rendered within the user interface 200 (e.g., at the preview section 200A of the user interface 200). After the first sentence 211A is replaced with the updated first sentence 211B, a user may be allowed to revert the replacement (e.g., via a reverting button displayed at the content-generation UI 200, not depicted). In some implementations, a first justification 211C can also be determined based on output of the second generative model during the first iteration of content refinement and be displayed within the user interface 200. For instance, the first justification 211C can be rendered when the first sentence 211A is highlighted and can remain being rendered while words in the first sentence 211A are automatically deleted one-by-one, and continue to stay being rendered while words of the updated first sentence 211B are rendered one-by-one. As a non-limiting example, the first justification 211C can include the following content: “The original sentence is repetitive with the use of phrases such as ‘I think’ and ‘I believe’. The suggested edit removes the repetition and makes the sentence more assertive and impactful.”

Referring to FIG. 1E and FIG. 1F, during a second iteration of content refinement, a second sentence 213A (which is different from the first sentence 211A) in the initial content can be edited by being replaced with an updated second sentence 213B. As a non-limiting example, the second sentence 213A can be “I think it is important to remember that not every innovation comes from a new product or service”, and the updated second sentence 213B can be—“It is crucial to remember that innovation isn't always about introducing a new product or service”. The replacement of the second sentence 213A with the updated second sentence 213B can be rendered within the user interface 200 (e.g., at the preview section 200A of the user interface 200). In some implementations, a second justification 213C can also be determined based on output of the second generative model during the second iteration and can be displayed within the user interface 200. As a non-limiting example, the first justification 213C can include the following content: “The original sentence is a bit weak due to the use of ‘I think’. The suggested edit removes this phrase to make the sentence more assertive. Additionally, the phrase ‘not every innovation comes from’ is replaced with ‘isn't always about’, which is more engaging and conversational.”

Referring to FIG. 1G and FIG. 1H, during a third iteration of content refinements, a third sentence 215A in the initial content can be edited by being replaced with an updated third sentence 215B. As a non-limiting example, the third sentence 215A can be “I think it is important that technology companies continue to innovate and explore new ways to serve their customers”, and the updated third sentence 215B can be—“It is vital that technology companies persist in innovating and exploring new ways to serve their customers”. The replacement of the third sentence 215A with the updated third sentence 215B can be rendered within the user interface 200 (e.g., at the preview section 200A of the user interface 200). In some implementations, a third justification 215C can also be determined based on output of the second generative model during the third iteration and be displayed within the user interface 200. As a non-limiting example, the third justification 215C can include the following content: “The phrase ‘I think it is important’ is somewhat weak and subjective. The revision makes the statement more assertive and emphasizes the urgency of need for continuous innovation in technology companies.”

As shown in FIGS. 2C˜2H, the first sentence 211A (which is replaced with the updated first sentence 211B in the first focused edit) may occur in the initial content 208A subsequent to the second sentence 213A. The second sentence 213A (which is replaced with the updated second sentence 213B in the second focused edit) may occur in the initial content 208A prior to the third sentence 215A (which is replaced with the updated third sentence 215B in the third focused edit) and prior to the first sentence 211A. This may be due to the first focused edit having a higher importance/priority level than the second focused edit, and the second focused edit having a higher importance/priority level than the third focused edit. In some implementations, the content-generation UI 200 can include a refinement-pausing element (not illustrated) that is selectable and when selected, causes the refinement using the second generative model to be paused.

It is noted that while FIGS. 2C˜2H illustrates three iterations of content refinement, there can be a higher number of iterations or a lower number of iterations. In some implementations, the total number of iterations can be predetermined (e.g., by a user via an iteration number-selecting button displayed at the content-generation UI 200, or via a default iteration number specified in the text prompt or provided to the second generative model). In some implementations, the total number of iterations may not be predetermined, and the iterations will come to a stop in response to an output of the second generative model for a particular iteration indicating that no focused edit is generated or necessary.

It is further noted that different text prompts can be processed (e.g., using the second generative model) during different iterations of content refinements. For instance, the text prompt processed during the first iteration can include the initial content 208A and the request for focused edit(s), the text prompt processed during the second iteration can include the initial content 208A that incorporates the first focused edit (generated during the first iteration) and the request for focused edit, and the text prompt processed during the third iteration can include the initial content 208A that incorporates both the first focused edit (generated during the first iteration) and the second focused edit (generated during the second iteration), and/or the request for focused edit(s). Put another way, the text prompt processed using the second generative model during a N^{th} iteration can include: (i) the initial content 208A that incorporates the first, second, . . . , and (N−1)^{th} focused edits, and/or (ii) the request for focused edit(s). Additionally, the text prompt can include a word-limit to control a length for the refined content, or can include other user-specified requests or limitations (e.g., a user specified request for format, etc.).

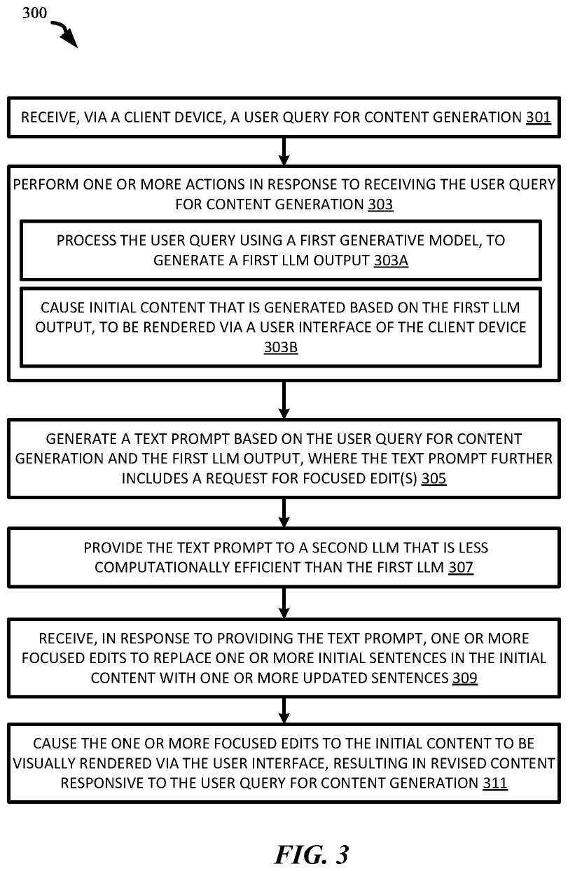

Turning now to FIG. 3, a flowchart is depicted that illustrates an example method of generating content responsive to a user request to generate content, in accordance with various aspects of the present disclosure. For convenience, the operations of the method 300 are described with reference to a system that performs the operations. This system of method 300 includes one or more processors, memory, and/or other component(s) of computing device(s) (e.g., client computing device 10 of FIG. 1, one or more servers, and/or other computing devices). For instance, the system can include the aforementioned LLM-based assistant (11 and/or 120). Moreover, while operations of the method 300 are shown in a particular order, this is not meant to be limiting. One or more operations may be reordered, omitted, and/or added.

At block 301, the system receives, via a client device, a user query for content generation. The user query for content generation (may be referred to simply as “user query”) can be based on user interface input at the client device, such as typed input, voice input, etc. The user query can be, for example, a voice query, a typed query, an image-based query, or a multimodal query (e.g., that includes voice input and an image).

In some implementations, when the user query includes content that is not in textual format, the system can convert the user query to a textual format or other format. For example, if the query is a voice query (e.g., directed to an automated assistant, such as the aforementioned LLM-based assistant 11), the system can perform automatic speech recognition (ASR) to convert the user query to textual format. As another example, the user query can be a typed query (e.g., which can be received at the content request input field 203a in FIG. 2A, such as “draft an email to Victor to tell him about my vacation”). The content request input field 203a can be, but does not need to be, associated with the LLM-based assistant.

As another example, assume the query is a multimodal query that includes an image of an avocado and a voice input of “is this healthy”. In this example, the system can perform ASR to convert the voice input to text form, can perform image processing on the image to recognize an avocado is present in the image, and can perform coreference resolution to replace “this” with “an avocado”, resulting in a textual format query of “is an avocado healthy”.

At block 303, the system performs one or more actions in response to receiving the user query for content generation, where performing the one or more actions includes: processing the user query using a first generative model (e.g., first LLM), to generate a first LLM output (303A); and causing initial content (e.g., an email or other text) that is generated based on the first LLM output, to be rendered via a user interface of the client device (303B).

At block 305, the system generates a text prompt based on the user query for content generation and the first LLM output, where the text prompt further includes a request for one or more focused edits (which may also be referred to as “request for focused edit(s)”, “request for focused edits”, “request for focused edit”, etc.).

In some implementations, the text prompt can include the user query for content generation, and the initial content generated based on the first LLM output, in addition to the request for one or more focused edits. The request for one or more focused edits can be a natural language request for replacing a segment (e.g. text segment or other portion) in the initial segment. For example, the request for one or more focused edits can be a natural language request for replacing or modifying a single sentence in the initial content. Alternatively, the request for one or more focused edits can be a natural language request for replacing a single paragraph in the initial content. Alternatively, the request for one or more focused edits can be a natural language request for replacing a particular or targeted segment (e.g., “an analysis session”) of the initial content. Alternatively, the request for one or more focused edits can be a natural language request for performing one or more iterations of content refinement and for determining or generating a focused edit that edits a single text segment (sentence, paragraph, etc.) per each iteration. Alternatively, the request for one or more focused edits can be a natural language request for performing a single iteration of content refinement and for determining the one or more focused edits all at once during the single iteration. Descriptions for the content and format of the request for one or more focused edits however are not limited thereto, and can be in any applicable manner.

In some implementations, the text prompt further includes a particular sentence refinement request to refine a particular initial sentence in the initial content. The particular sentence refinement request can be generated based on the first LLM output indicating the particular sentence to be refined.

In some implementations, generating the text prompt based on the user query and the initial content can include: filtering the initial content to redact privacy information from the initial content, thereby generating a redacted version of the initial content; and generating the text prompt to include the user query and the redacted version of the initial content.

At block 307, the system provides the text prompt to a second LLM that is less computationally efficient than the first LLM. In some implementations, the first LLM can be a smaller LLM having less than 100 billion parameters, while the second LLM can be a larger LLM that includes over 200 billion parameters. In some implementations, the first LLM can be a smaller LLM that includes twenty, thirty, forty, fifty, or other percent fewer parameters than the larger LLM. In some implementations, the first LLM and the second LLM can be both in communication with the aforementioned LLM-based assistant. For instance, the LLM-based assistant can access the first LLM for content generation in response to receiving the user query for content generation, and the LLM-based assistant can access the second LLM for content refinement (e.g., by generating and forwarding a text prompt that includes the user query for content generation and initial content responsive to the user query for content generation generated using the first LLM).

In some implementations, the smaller LLM can be a distilled, quantized and/or pruned version of the larger LLM. In some other implementations, the smaller LLM is not a quantized and/or pruned version of the larger LLM but, instead, is wholly independent of the larger LLM. For example, the smaller LLM can have a different architecture relative to the larger LLM and/or can be trained on a unique set of training data relative to the larger LLM. For instance, the input dimensions of the smaller LLM can be smaller than those of the larger LLM, the output dimensions of the smaller LLM can be smaller than those of the larger LLM, and/or the smaller LLM can include various intermediate layers that vary in size and/or type relative to those of the larger LLM.

The smaller LLM can be more computationally efficient than the larger LLM. For example, processing a request utilizing the smaller LLM can occur with less latency than processing the request utilizing the larger LLM. As another example, processing the request utilizing the smaller LLM can utilize less memory, processor, and/or power resource(s) than processing the request utilizing the larger LLM. In some implementations, the smaller LLM can be on-device at the client device, and the larger LLM can be remote to the client device. For instance, the larger LLM can be at a server device that is in communication with the client device.

In some implementations, the first LLM can be local to the client device, and the second LLM can be remote to the client device. In some other implementations, the first LLM can be local to the client device, and the second LLM can also be local to the client device. In some implementations, the first LLM can be remote to the client device, and the second LLM can also be remote to the client device.

Due to the relatively small size of the first LLM, memory, processor, power, and/or other computational resource(s) required to process the user query for content generation using the first LLM (in order to generate the initial content) can be relatively insignificant. Also, due to the relatively small size of the first LLM, a latency in generating the initial content and, as a result, in rendering the initial content, can be relatively insignificant. Such insignificant latency may allow the user to review, read, and revise the initial content while the initial content is being transmitted and/or processed for refinements using the second LLM that is of a relatively large size (e.g., having parameters in the order of billions, tens of billions, a hundred of billions, etc.). By utilizing the second LLM, implementations are also able to ensure or improve accuracy of the content provided responsive to the user query for content generation.

At block 309, the system receives, in response to providing the text prompt, one or more focused edits to replace one or more initial sentences in the initial content with one or more updated sentences, where the one or more focused edits can be generated based on processing of the text prompt using the second LLM for one or more iterations. At block 311, the system causes the one or more focused edits to the initial content to be visually rendered via the user interface, resulting in revised content responsive to the user query for content generation.

In some implementations, the system can cause the one or more focused edits to the initial version of the document to be visually rendered via the user interface by: causing a first focused edit to the initial content to be visually rendered via the user interface, and causing a second focused edit to be visually rendered via the user interface. The first focused edit can be generated during a first iteration of the one or more iterations and can replace a first initial sentence in the initial content with a first updated sentence. The second focused edit can be generated during a second iteration of the one or more iterations and can replace a second initial sentence in the initial content with a second updated sentence. The second initial sentence is different from the first initial sentence. For example, the second initial sentence can occur in the initial content earlier than the first initial sentence. Put another way, the one or more focused edits to the initial content does not occur based on an order of sentence(s) in the initial content. Instead, the occurrence order of the one or more focused edits to the initial content can be based on an importance level of a sentence in the initial content.

In some implementations, the system can receive, via the user interface, a first user edit from the user (e.g., a human user), while the one or more focused edits (i.e., determined using the second LLM, which can be referred to as “LLM-based edit(s)”) are being applied to the initial content. In these implementations, the system can cause the first user edit to be applied to the initial document while the one or more focused edits are being applied to the initial content.

In some implementations, the system can receive, via the user interface, a second user edit to the revised content (i.e., after all the one or more focused edits are applied to the initial content). In these implementations, the system can cause the second user edit to be visually applied to the revised content.

In some implementations, the system can further generate a training instance for the first LLM. The training instance can include the user query for content generation as a training instance input, and the revised content as a ground truth output. In some implementations, the system can further train the first LLM using the generated training instance. For instance, the system can train the first LLM by processing the user query for content generation as input using the first LLM, to generate an output of the first LLM, comparing the output of the first LLM with the ground truth output, and updating one or more weights of the first LLM based on comparing the output of the first LLM with the ground truth output.

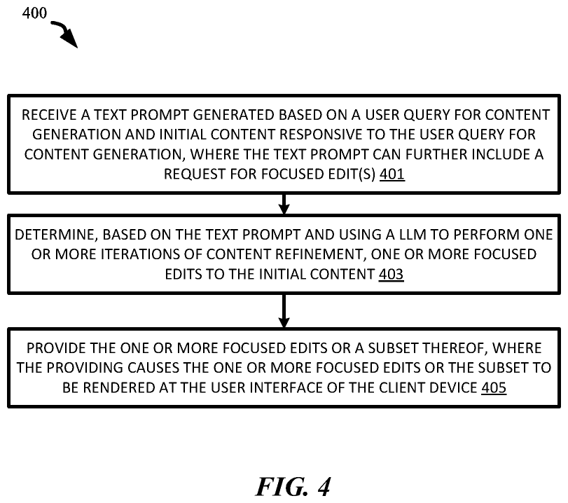

Turning now to FIG. 4, a flowchart is depicted that illustrates another example method of generating content responsive to a user request to generate content, in accordance with various aspects of the present disclosure. This system of method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

At block 401, the system receives a text prompt generated based on initial content generated in response to a user query for content generation, where the text prompt can further include a request for focused edit(s). The user query can be an audio input or a typed input (or other applicable type of input) received via a client device. The initial content can be visually rendered via a user interface of the client device, as a preview of content generation for review by a user (e.g., human user that provides the user query) of the client device. The request for focused edit(s) can be, for instance, to replace a single sentence (or other text segment, such as a paragraph, etc.) in the initial content with an updated sentence per each iteration of content refinement, or can be to replace multiple sentences using a single iteration of content refinement. The request for focused edit(s) are not limited herein. For example, the request for focused edit(s) can also be a text request that replaces or modifies multiple sentences per each iteration of one or more iterations of content refinement.

In some implementations, the text prompt can include the initial content and the request for focused edit(s). In some other implementations, the initial content can be filtered to exclude or redact privacy information, resulting in filtered initial content. In these implementations, due to privacy concerns, the text prompt can include the filtered initial content (instead of the initial content) and the request for focused edit(s), prior to being received (e.g., at a server device).

At block 403, the system determines, based on the text prompt and using a LLM to perform one or more iterations of content refinement, one or more focused edits to the initial content. In some implementations, the initial content responsive to the user query for content generation is generated based on processing of the user query for content generation using an additional LLM having a less quantity of parameters than the LLM.

In some implementations, the LLM can be accessible via a server device, and the text prompt can be processed using the LLM during a first iteration of content refinement, to generate a first output of the second generative model from which a first focused edit is generated. In these implementations, the text prompt can be modified to include or reflect the first focused edit prior to the second iteration of content refinement. For instance, the text prompt can be modified to include the initial content that has a first sentence replaced or revised based on the first focused edit, in addition to including the request for focused edit(s). Such modified text prompt can be processed as input, using the second generative model during a second iteration of content refinement, to generate a second output of the second generative model from which a second focused edit is determined/generated. This content refinement process can be repeated until a predetermined number of iterations of content refinement is reached or until an output of the second generative model indicates no focused edit.

In some implementations, the LLM can be a larger LLM having a larger quantity of parameters (e.g., in the order of 100 billion), and the additional LLM can be a smaller LLM having a smaller quantity of parameters (e.g., in the order of 1 billion).

In some implementations, the smaller LLM can be a quantized and/or pruned version of the larger LLM. In some other implementations, the smaller LLM is not a quantized and/or pruned version of the larger LLM but, instead, is wholly independent of the larger LLM. For example, the smaller LLM can have a different architecture relative to the larger LLM and/or can be trained on a unique set of training data relative to the larger LLM. For instance, the input dimensions of the smaller LLM can be smaller than those of the larger LLM, the output dimensions of the smaller LLM can be smaller than those of the larger LLM, and/or the smaller LLM can include various intermediate layers that vary in size and/or type relative to those of the larger LLM.

The smaller LLM can be more computationally efficient than the larger LLM. For example, processing a request utilizing the smaller LLM can occur with less latency than processing the request utilizing the larger LLM. As another example, processing the request utilizing the smaller LLM can utilize less memory, processor, and/or power resource(s) than processing the request utilizing the larger LLM. In some implementations, the smaller LLM can be on-device at the client device, and the larger LLM can be remote to the client device. For instance, the larger LLM can be at a server device that is in communication with the client device.

At block 405, the system provides the one or more focused edits to the initial content or a subset of the one or more focused edits, where the providing causes the one or more focused edits or the subset to be rendered at the user interface of the client device.

In some implementations, the system provides the one or more focused edits to the initial content or a subset of the one or more focused edits by: providing the first focused edit to the initial content at completion of the first iteration of content refinement and prior to completion of a second iteration of content refinement, and providing a second focused edit different from the first focused edit at completion of the second iteration of content refinement.

It is noted that, the output of the second generative model during each of the one or more iterations of content refinement can include a confidence score for recommending a corresponding focused edit to be rendered. The subset of the one or more focused edits can be provided to be rendered instead of all the one or more focused edits, based on each focused edit from the subset correspond to a confidence score that satisfies a rendering recommendation threshold score and based on other focused edits not from the subset correspond to confidence score not satisfying the rendering recommendation threshold score.

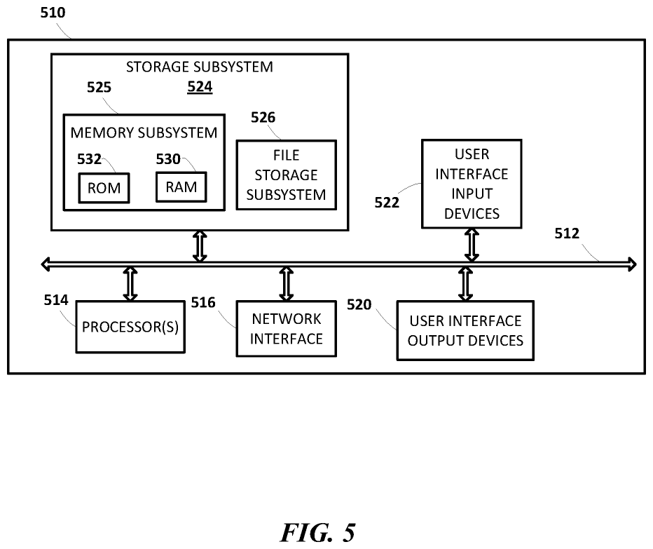

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple buses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving, via a client device, a user query for content generation
in response to receiving the user query for content generation,
processing the user query using a first LLM, to generate a first LLM output,
causing initial content, that is based on the first LLM output to be rendered via a user interface of the client device;
generating a text prompt based on the first LLM output, the text prompt further including a request for one or more focused edits;
providing the text prompt to a second LLM that is less computationally efficient than the first LLM,
receiving, in response to providing the text prompt, one or more focused edits to replace one or more initial segments in the initial content with one or more updated segments,
wherein the one or more focused edits are generated using the second LLM to perform one or more iterations of content refinement based on the text prompt; and
causing the one or more focused edits to the initial content to be visually rendered via the user interface, resulting in revised content responsive to the user query for content generation.

2. The method of claim 1, wherein the one or more initial segments each corresponds to a sentence, and wherein causing the one or more focused edits to the initial version of the document to be visually rendered via the user interface comprises:
causing a first focused edit to the initial content to be visually rendered via the user interface, wherein the first focused edit is generated during a first iteration of content refinement and replaces a first initial sentence in the initial content with a first updated sentence, and
causing a second focused edit to be visually rendered via the user interface, wherein the second focused edit is generated during a second iteration of content refinement and replaces a second initial sentence in the initial content with a second updated sentence, the second initial sentence being different from the first initial sentence.

3. The method of claim 2, wherein the text prompt is processed as input using the second LLM during the first iteration to generate the first focused edit, and wherein a second text prompt different from the text prompt is processed as input using the second LLM during the second iteration to generate the second focused edit.

4. The method of claim 3, wherein the second text prompt corresponds to the text prompt incorporating the first focused edit to the initial content.

5. The method of claim 1, further comprising:
receiving, via the user interface, a first user edit while the one or more focused edits are being applied to the initial content; and
causing the first user edit to be applied to the initial document while the one or more focused edits are being applied to the initial content.

6. The method of claim 1, further comprising:
receiving, via the user interface, a second user edit to the revised content; and
causing the second user edit to be applied to the revised content.

7. The method of claim 1, wherein the request for one or more focused edits is a request for replacing a single sentence or a single paragraph in the initial content during each iteration of the one or more iterations.

8. The method of claim 1, wherein the text prompt includes the initial content generated based on the first LLM output.

9. The method of claim 1, wherein the text prompt further includes a particular sentence refinement request to refine a particular initial sentence in the initial content.

10. The method of claim 9, wherein the particular sentence refinement request is generated based on the first LLM output indicating the particular sentence to be refined.

11. The method of claim 1, wherein generating the text prompt based on the user query and the initial content comprises:
filtering the initial content to redact privacy information from the initial content, thereby generating a redacted version of the initial content; and
generating the text prompt to include the redacted version of the initial content.

12. The method of claim 1, further comprising:
generating a training instance for the first LLM, wherein the training instance includes:
the user query for content generation as a training instance input, and
the revised content as a ground truth output.

13. The method of claim 12, further comprising:
training the first LLM using the generated training instance, including:
processing the user query for content generation as input using the first LLM, to generate an output of the first LLM,
comparing the output of the first LLM with the ground truth output, and
updating one or more weights of the first LLM based on comparing the output of the first LLM with the ground truth output.

14. A method implemented by one or more processors, the method comprising:
receiving a text prompt generated based on a user query for content generation and initial content responsive to the user query for content generation, the text prompt further including a request for one or more focused edits,
wherein the user query is received via a client device, and
wherein the initial content is visually rendered via a user interface of the client device;
determining, based on the text prompt and using a LLM to perform one or more iterations of content refinement, one or more focused edits to the initial content; and
providing the one or more focused edits or a subset of the one or more focused edits, the providing causes the one or more focused edits or the subset to be rendered at the user interface of the client device.

15. The method of claim 14, wherein the initial content responsive to the user query for content generation is generated based on processing of the user query for content generation using an additional LLM, the additional LLM having a less quantity of parameters than the LLM.

16. The method of claim 14, wherein the request for one or more focused edits is to replace a single sentence in the initial content with an updated sentence.

17. The method of claim 14, wherein providing the one or more focused edits or the subset comprises:
providing a first focused edit to the initial content at completion of a first iteration of content refinement and prior to completion of a second iteration of content refinement, and
providing a second focused edit different from the first focused edit at completion of the second iteration of content refinement.

18. The method of claim 14, wherein the text prompt includes the initial content generated based on the first LLM output that corresponds to the user query for content generation, in addition to the request for one or more focused edits.

19. The method of claim 14, wherein the initial content is modified to exclude privacy information, and the text prompt includes the modified initial content and the request for one or more focused edits.

20. A method implemented by one or more processors, the method comprising:
receiving, via a client device, a spoken user query for content generation
in response to receiving the spoken user query for content generation,
processing the spoken user query to generate a speech recognition of the spoken user query in natural language,
processing the speech recognition of the spoken user query using a first LLM, to generate a first LLM output, and
causing initial content that is based on the first LLM output to be rendered via a user interface of the client device;
generating a text prompt that includes the speech recognition of the user query for content generation, the initial content generated based on the first LLM output, and a request for one or more focused edits;
providing the text prompt to a second LLM that is less computationally efficient than the first LLM,
receiving, in response to providing the text prompt, one or more focused edits to replace one or more initial segments in the initial content with one or more updated segments, the one or more focused edits being generated based on processing of the text prompt using the second LLM for one or more iterations of content refinement, and
causing the one or more focused edits to the initial content to be visually rendered via the user interface, resulting in revised content responsive to the spoken user query for content generation.
